(19) United States
(12) Patent Application Publication
(10) Pub. No.: US 2016/0283469 A1
(43) Pub. Date: Sep. 29, 2016

(54) WEARABLE TRANSLATION DEVICE

(71) Applicant: Babelman LLC, Edmonds, WA (US)

(72) Inventor: Charles D. Gold, Edmonds, WA (US)

(73) Assignee: Babelman LLC, Edmonds, WA (US)

(21) Appl. No.: 15/017,431

(22) Filed: Feb. 5, 2016

Related U.S. Application Data
(60) Provisional application No. 62/177,903, filed on Mar. 25, 2015.

(51) Int. Cl. G06F 17/28; G10L 21/034; H04R 29/00; G10L 13/04; G10L 15/26

(52) U.S. Cl. CPC G06F 17/289; G10L 13/043; G10L 15/265; H04R 29/001; G10L 21/034

(57) ABSTRACT

A wearable translation device that provides real-time language translation without a network connection is provided. The wearable translation device picks up speech from a user in a first language using a microphone facing the user, translates it into a second language, and outputs synthesized speech in the second language through a speaker facing the listener. The use of large speakers allows for greater comprehensibility than with existing systems. In some embodiments, noise cancellation signals are output through a speaker facing the user to reduce the amount of the user's voice and ambient background noise that is audible to the listener. In some embodiments, the wearable translation device provides two-way translation.

### CROSS-REFERENCE(S) TO RELATED APPLICATION(S)

This application claims the benefit of Provisional Application No. 62/177,903, filed Mar. 25, 2015, the entire disclosure of which is hereby incorporated by reference for all purposes.

### BACKGROUND

There were many early studies on translation software and general patents on the subject without device specifics. An important early work was for DARPA, a U.S. Government initiative to create a translator. Although the first patent cited in a translator patent application is in 1984, the DARPA study in the 1990's on developing translation software that was published in 2000, The Spoken Language Translator, by Manny Rayner, David Carter, Pierrette Bouillon, Vassilis Digalakis and Mats Wiren. These much less sophisticated and useable efforts began with the Phraseolator intended to be used by the US military and not available publicly, assigned to Vox Tec, with patent applied for in 2003, finally granted in 2011 after several refusals. Franklin, Ectaco and many others have also been making bulky, phrase-based translators. While the more reasonably sized Ili uses voice input, it fails to work around ambient noise. All of these are merely stored phrased-based translators with limited function. It is obvious from this that we have not progressed from typing or rarely speaking in a stored phrase to be translated. Trying to have a real conversation using a phrase-based translator is an exercise in frustration that is all about the machine and not the conversation, and will never be the goal of a device to enable inter-lingual conversations between people. The need for noise cancellation in real environments with background noise or larger groups can only be solved with high volume/directional/and low distortion, showing the needed form factor.

The other translation device attempt was by Google in 2013, where they planned to introduce an application for Android phones called “Googlebabel”. Although this approach was limited to cell phone signal coverage and clarity, cloud access, and was intended to be one way only, it was reported to have a high degree of accuracy in an environment with all background noise removed. It was never introduced, due to its limitations, which cannot be solved properly with a cell phone application using the tiny, non-directional speakers of a cell phone, and a cell phone's other drawbacks. Currently, an Android cell phone app is available with very limited utility.

One reason that cell phones will never work as hardware for an effective and intuitive conversational wearable translation device is the lack of sufficient directional speakers. The problem with Siri, Google, and other voice-to-text applications is that any background noise degrades the accuracy and renders them unusable. Strong, directional speakers are needed for outdoor and/or other noisier environments for output of translated speech. This was why Google has apparently abandoned the Googlebabel translation program, which only worked in an absolutely quiet environment.

Also, cellphones are restricted to the availability and quality of a cell signal. Privacy has become a famous issue with the revelations of Edward Snowden about NSA surveillance and Angela Merkel's (Chancellor of Germany) personal calls being monitored.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a handheld translation device is provided. The handheld translation device comprises, a housing, a first loudspeaker, a second loudspeaker, a first microphone, a second microphone, a computer-readable medium, a translation engine, and a voice cancelling engine. The housing has a first side and a second side, and is configured to be held with the first side facing a speaker and the second side facing a listener. The first loudspeaker is positioned within the housing and faces the first side of the housing. The second loudspeaker is positioned within the housing and faces the second side of the housing. The first microphone faces the first side of the housing for detecting speech input from the speaker. The second microphone faces the second side of the housing for detecting speech input from the listener. The computer-readable medium has at least one translation database stored thereon, the at least one translation database providing data to enable translation between a first language and a second language. The translation engine is configured to receive speech input from the speaker via the first microphone, translate the speech input from the first language to the second language using the at least one translation database to create translated speech input, synthesize translated speech output based on the translated speech input; and transmit the translated speech output using the second loudspeaker. The voice cancelling engine configured to generate a voice canceling signal based on the speech input, and transmit the voice canceling signal via the first loudspeaker or the second loudspeaker.

In some embodiments, a translation device is provided. The translation device is configured to receive voice input in a first language; translate the voice input to a second language; output translated voice output in the second language; and output a noise cancelling signal based on the voice input.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a front view of a wearable translation device according to various aspects of the present disclosure;

FIG. 2 is a back view of a wearable translation device according to various aspects of the present disclosure;

FIG. 3 is another front view of a wearable translation device according to various aspects of the present disclosure;

FIG. 4 is a first top perspective view of a wearable translation device according to various aspects of the present disclosure;

FIG. 5 is a second top perspective view of a wearable translation device according to various aspects of the present disclosure;

FIG. 6 is a bottom perspective view of a wearable translation device according to various aspects of the present disclosure;

FIG. 7 is a side view of a wearable translation device according to various aspects of the present disclosure;

FIG. 8 illustrates the use of an exemplary embodiment of a wearable translation device according to various aspects of the present disclosure;

FIG. 9 illustrates an exemplary embodiment of a wearable translation device and a storage pouch according to various aspects of the present disclosure; and

FIGS. 10A and 10B are schematic diagrams that illustrate interactions between components of a wearable translation device according to various aspects of the present disclosure.

### DETAILED DESCRIPTION

The highest form of communication throughout human history has been the face-to-face meeting, where two or more people meet privately to discuss anything from war to peace to business to romance, etc. Even in this age of Skype, Facetime, etc., people routinely travel all over the world, often on business, to have these most important conversations and interactions in person. In some places, such as Europe, people do not have to travel far to cross into an area with a different language. Embodiments of the present disclosure provide a wearable technology device that promises to eliminate the age-old language barrier in both the developed and underdeveloped worlds, enabling both critical high level discussions, presentations, negotiations and relationships between politicians, businesspeople, and the personal conversations of the common man wherever they travel.

Voice-to-text programs, whose use is just becoming mainstream, have been slow, but Intel has just introduced and is licensing through Nouvaris a superior and much faster voice-to-text independent system chip that needs no cloud or cell phone connection. The answer to maximize the utility of translation devices is combining such independent translation technology along with noise cancellation technology in a dedicated device. The combination of such features in a dedicated device can greatly increase usability and accuracy.

With the wearable translation device described herein, these conversations, presentations, or speeches become fully LIVE and PRIVATE for the speaker and intended listener(s), without the need of a hired translator; a cell phone or other network connected device that involves using the cell, internet, or cloud connections for providing translation services; or a device that is limited to a small number of stored phrases. Not using a network for translation services adds the crucial benefit of security, and voice synthesis technology can recreate the actual user's voice for any face-to-face meeting, from a simple conversation to a discussion of the fate of nations or businesses. Colloquial speech, jokes, innuendos, dialects, and characteristics of interactions among people without a language barrier become commonplace between people of different languages and cultures, greatly enhancing the quality of international discourse. Because a near-simultaneous translation can be provided by embodiments of the present disclosure, facial expressions and other body language will be visible nearly simultaneously with the associated speech uttered.

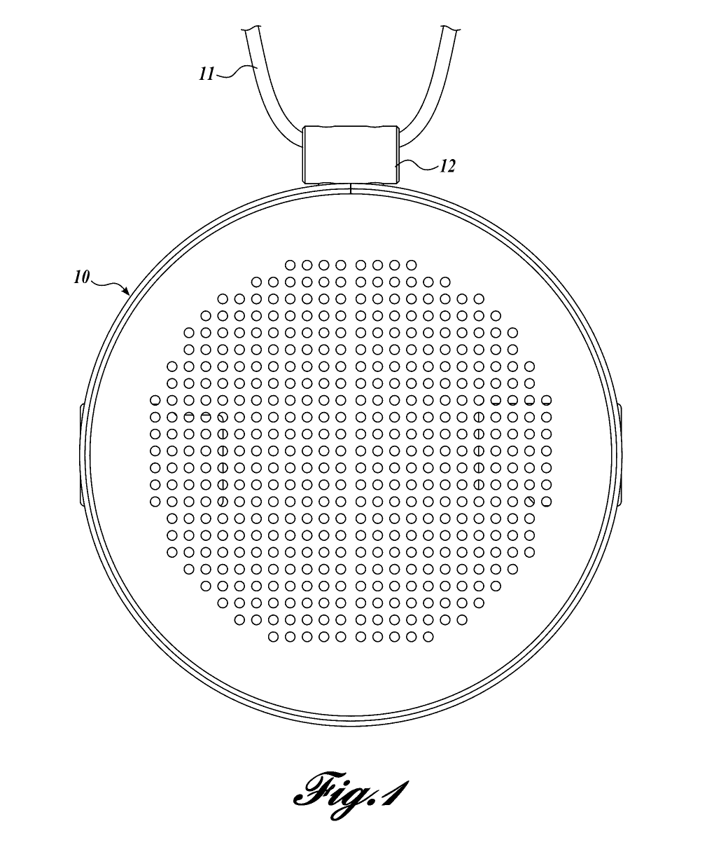

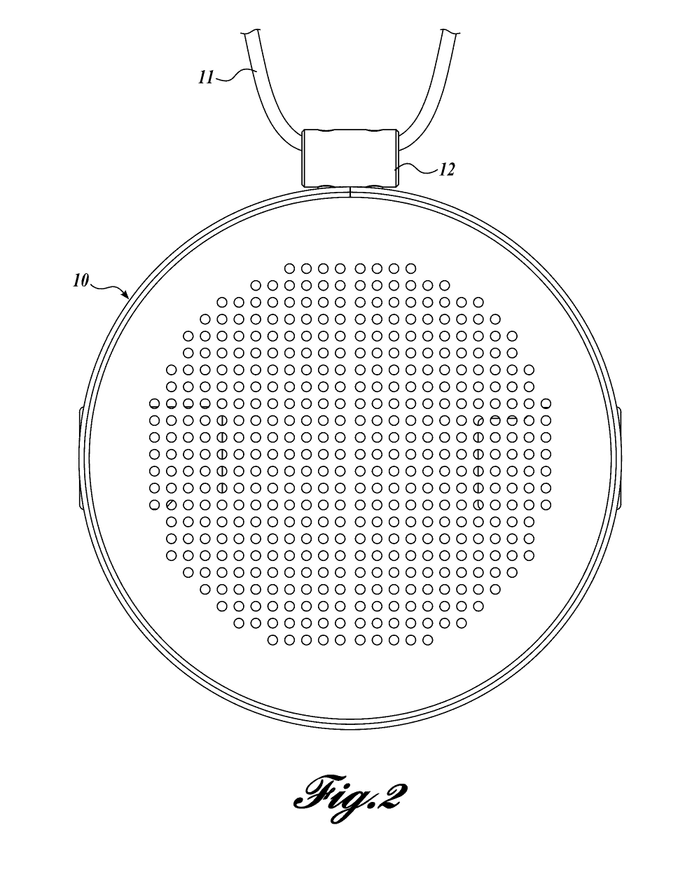

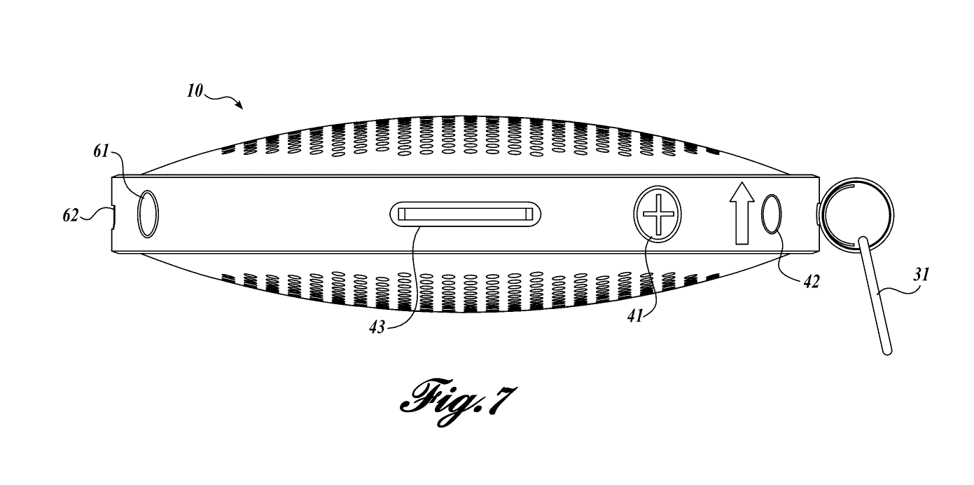

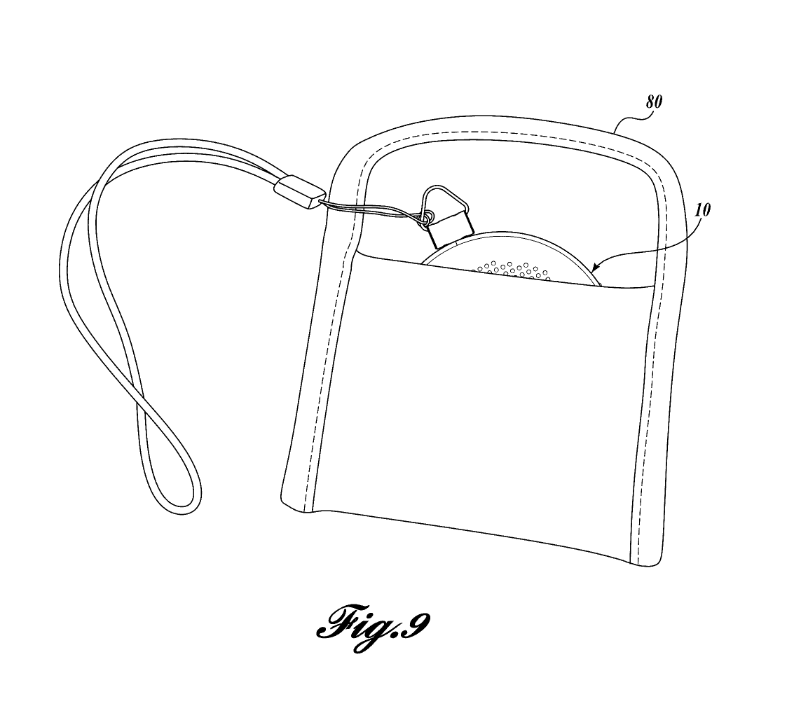

FIGS. 1-9 show exemplary embodiments of a wearable translation device according to various aspects of the present disclosure. FIG. 1 shows a front view and FIG. 2 shows a back view of an exemplary wearable translation device 10 according to various aspects of the present disclosure. The device 10 includes a hang loop 12, through which may be fed a lanyard 11. One of ordinary skill in the art will recognize that various changes may be made to the shape, size, and appearance of the wearable translation device without departing from the spirit and scope of the inventions. As illustrated, the wearable translation device uses an attractive, intuitive form factor and functionality. Shown in the FIGURES are examples that have all stainless steel cases, although the cases can be made from many materials, including aluminum, plastics, etc. and can be colored or even decorated in special addition jewelry forms. An example diameter of the illustrated embodiments is 2.25″ (approximately 57 mm), and an example thickness is approximately ⅝″ (16.6 mm). The device 10 can be, for instance, worn as a pendant on a necklace, either outside or under clothing, or carried in a belt loop or other case 80 (as shown in FIG. 9), kept in a pocket, and/or handled with a wrist strap for convenience and security.

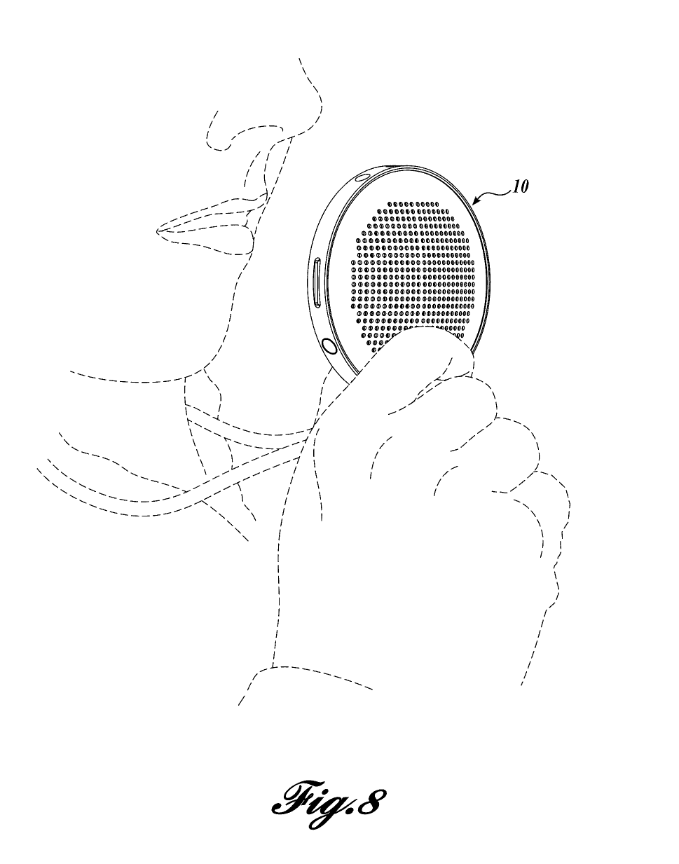

To use the wearable translation device 10, the user positions the device, as shown in FIG. 8, in front of his/her mouth with a first side facing the user and a second side facing the listener. Although the user is illustrated as holding the device inverted (with the hanging loop pointing downward), with a longer neck chain or wrist strap, it could be used upright (with the hanging loop pointing upward), as shown in the other FIGURES.

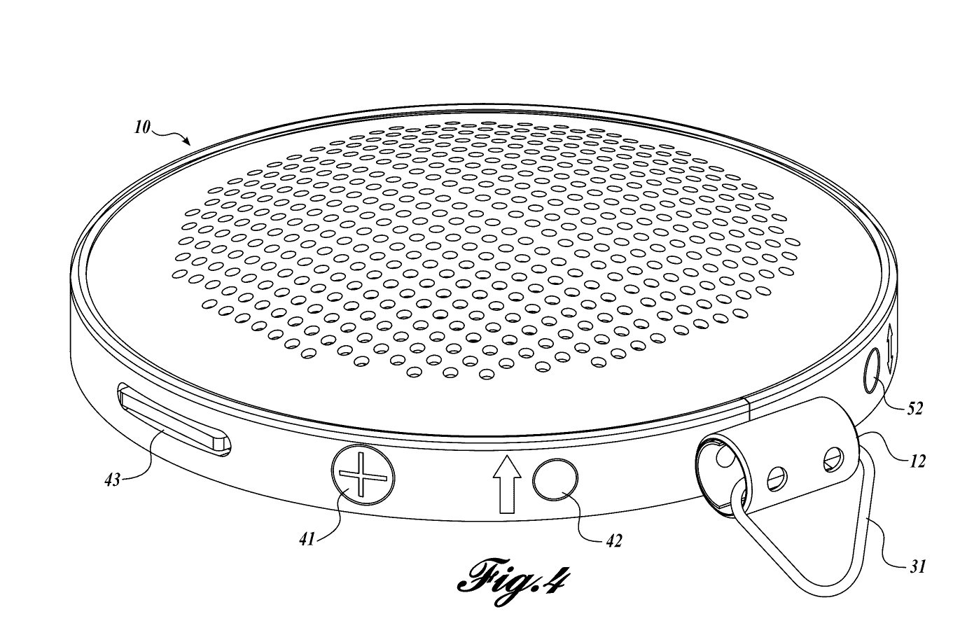

FIG. 4 is a perspective view that illustrates controls on the top of the wearable translation device 10. The user pushes the “+” button 41 on the rim of the device once, and the green LED light 42 will come on, indicating ready for speaker to listener operation. If the device needs warm up or boot up time, this green LED will flash, and the device is ready to use when the light glows steady on. The user then either directs the device verbally as to which language to output with a simple spoken command, like “Japanese”, which would indicate the user is using English and the output should be Japanese, or has the listener speak into the listener's side of the device and the device will detect the language output needed. The user then begins speaking. As the user speaks, the listener hears, with slight delay, a synthesized voice (which can be a synthesized voice intended to mimic the user's own voice) speaking in, for example, Japanese.

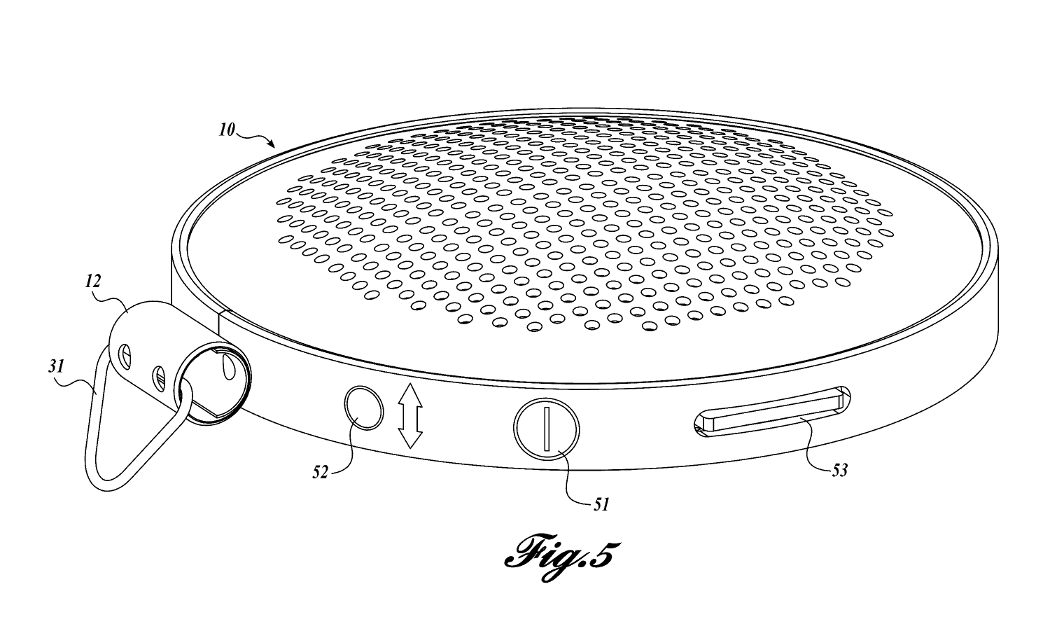

In some embodiments, a ranging device adjusts the needed volume for the conversation by measuring a distance between the device and the listener. In some embodiments, a manual volume adjustment can be effected by the “−” button 52, shown in FIG. 5. In some embodiments, the voice of the user speaking English is actively noise cancelled in addition to the background noises coming into the microphone on the user's side, as much as possible, leaving an accurate clear rendition of the user's talk in Japanese coming out of the speaker facing the listener.

In some embodiments of use, the listener also has a wearable translation device, and the conversation can proceed naturally with the listener using his/her device in the same way. In some embodiments, only the user (and not the listener) has the wearable translation device. In some embodiments, two-way translation may be performed by handing the device back and forth between the user and the listener. In some embodiment, two-way translation may be performed by a single device. If the user pushes the “+” button 41 again, or originally pushes it twice, the red LED light 52 will come on near the double arrow, indicating two-way conversation. The wearable translation device will work in the same way, except the device will switch the direction of noise cancelling and translated speech output, depending on who is speaking.

If the user pushes the “+” button 41 again, or 3 times total, the device will turn off. So the “+” button 41 controls On, One way translation (green LED 42), Two way translation (red LED 52), and Off. The “−” button 51 is fine tune volume of the output, going up to maximum and then back to minimum, depending on the needs of the situation for the conversation.

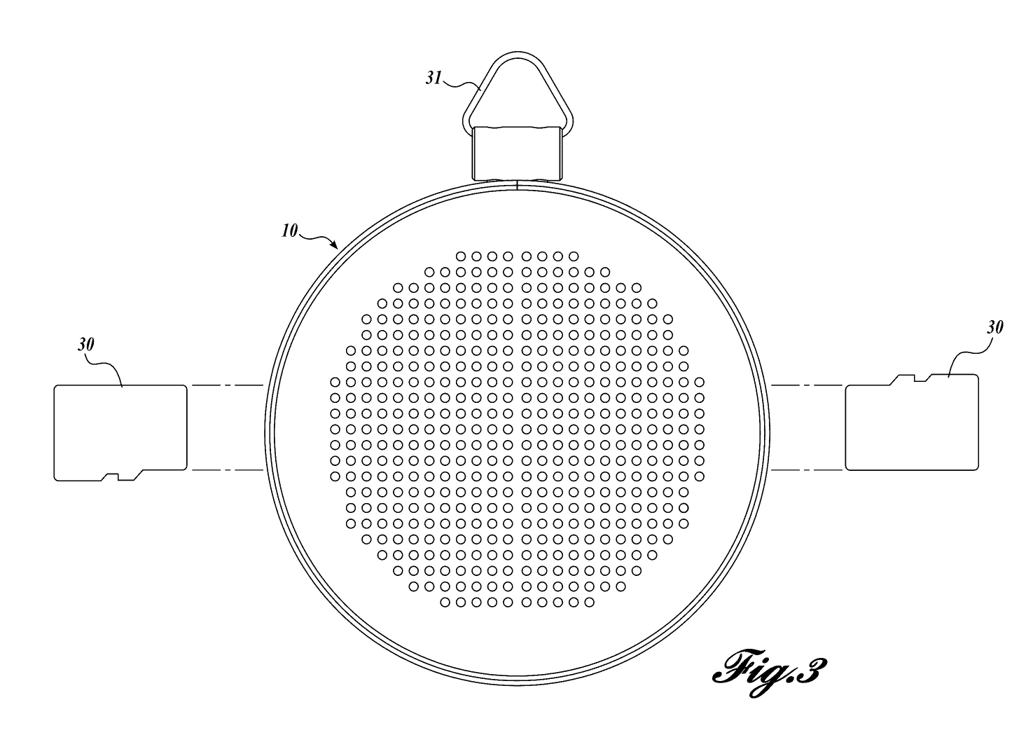

The slots 43, 53 in the sides of the device are equipped with push-push type micro SD card slots. In some embodiments, 512 GB micro SD cards, such as the cards 30 illustrated in FIG. 3, may be used, giving a total of 1.024 terabytes of memory. This is easily enough to store the complete dictionaries of all common languages, plus additional context libraries. If only a single language or family of languages is desired to be sold in a more basic model for marketing purposes, lower capacity cards can be used. As more powerful micro SD cards are developed, the wearable translation device can include have 3 or 4 terabytes or more of memory using micro SD cards, which is enough to contain the dictionaries and contextual equivalent phraseology of virtually every language no matter how obscure for those that need or want that. FIG. 3 also shows that the hang loop may hold other attachment hardware than the lanyard, such as a ring 31.

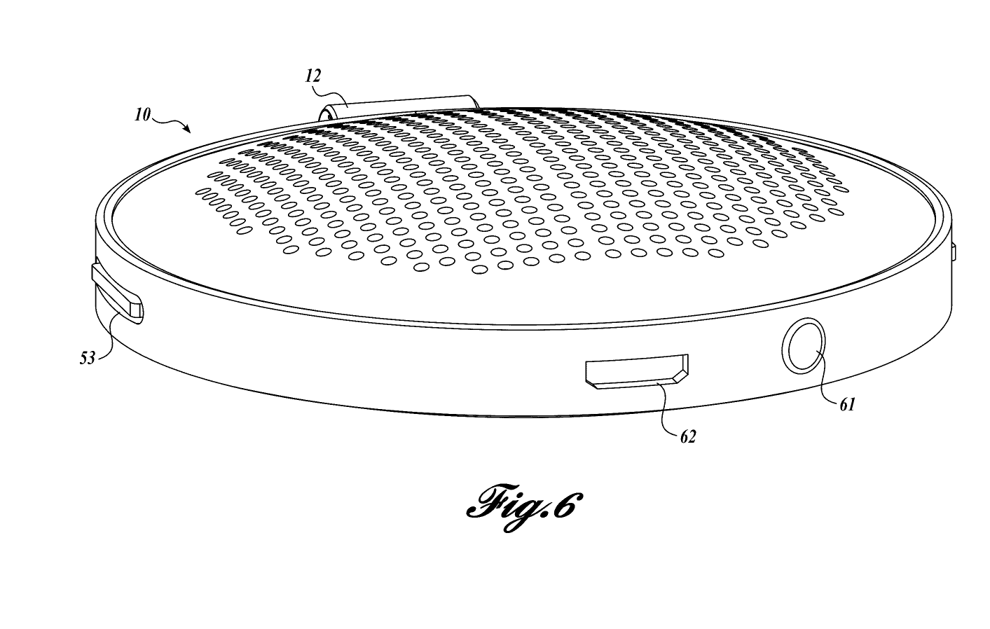

FIG. 6 illustrates a bottom perspective view of the wearable translation device 10. In some embodiments, on the bottom side of the wearable translation device 10 is a standard audio jack 61, such as a 3.5 mm jack or other connection, which can be used to connect to a PA system for a speech to a small or even very large group in their own language, auxiliary speakers, etc. It can also be used for headphones in a situation where that would be beneficial.

In some embodiments, the bottom of the wearable translation device 10 includes a micro USB female port 62 to use for a computer connection update, charging of the rechargeable battery in the device, or other connections and information transfer. In some embodiments, other types of connectors may be used to connect the wearable translation device to a computing device. In some embodiments, the wearable communication device 10 explicitly does not use an internet or cloud connection for convenience and privacy.

The entire design of the device is elegant, compact, simple, natural and unobtrusive to use. It is preferable to keep the interface simple to the user like this and automated in function to keep the number of controls very limited like the illustrated embodiments (i.e., no LED or LCD screen, menu choice, etc). This form factor in itself is a breakthrough back to simplicity and user friendliness that anyone around the world can easily use. The sophistication of the device is in how SIMPLE, natural, and unintimidating it is in use, not in outwardly displaying its complexity. In a conversation, it is designed to not require further attention after initial start-up, so it becomes virtually invisible.

Embodiments of the present disclosure may include one or more components, such as ASICs, FPGAs, or other stand-alone computing devices configured to provide the following functionality:

(1) Speech-to-text conversion component—Just now becoming more mainstream and usable in cell phones and devices

(2) Text-to-text translation component—with detection of other speaker's language—Again, just reaching the stage of very high accuracy and speed within a language “family”, with the near-term potential for more sophistication of dialects, customs, Asian-Western or other non-related languages, specialized polite speech situations, etc.

(3) Text-to-Speech generation component—Far more accurate and realistic, capable of simulating the speaker's own voice, or the voice of a celebrity, by voice “cloning”, although any clear voice would work. Large speakers enable fidelity and low distortion of sound.

(4) Noise Cancellation component—A technology, which has had many years to develop and is key to eliminating background noise and suppressing the user's incoming speech and background noise to create a truly accurate clear translated speech for the listener. Background noise, as it is for regular conversation between people speaking the same language, has been the main reason accurate spoken translation has been hampered and will not achieve success in a cell phone, which Google found out in 2013 with Googlebabel. To be successful with this breakthrough, directional powerful speakers and microphones are necessary in a configuration like the illustrated embodiments, which are central to the clarity and accuracy of this device. Aside from plugging into the standard audio connector to public address systems or other output speakers for presentations, Bluetooth technology is also included in some embodiments.

In some embodiments, speech-to-speech translation may be used, which would eliminate the steps involving text. The text-to-text translation allows full sentences to be translated, taking into account different sentence structures and time to analyze context.

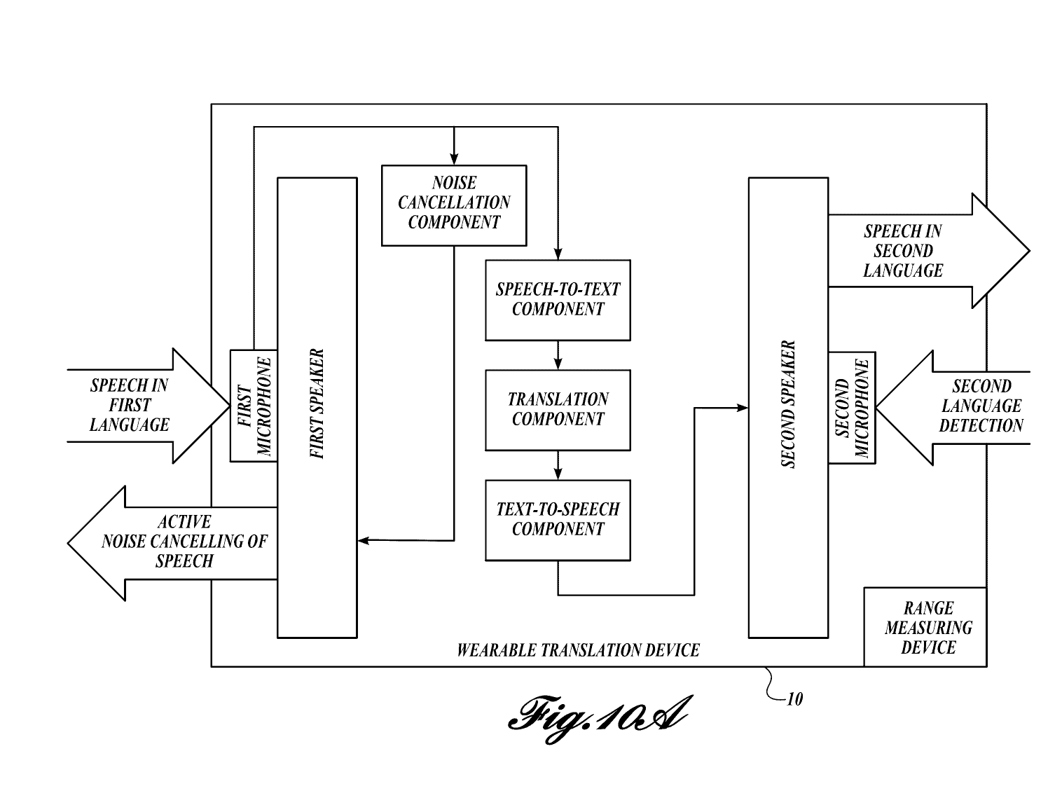

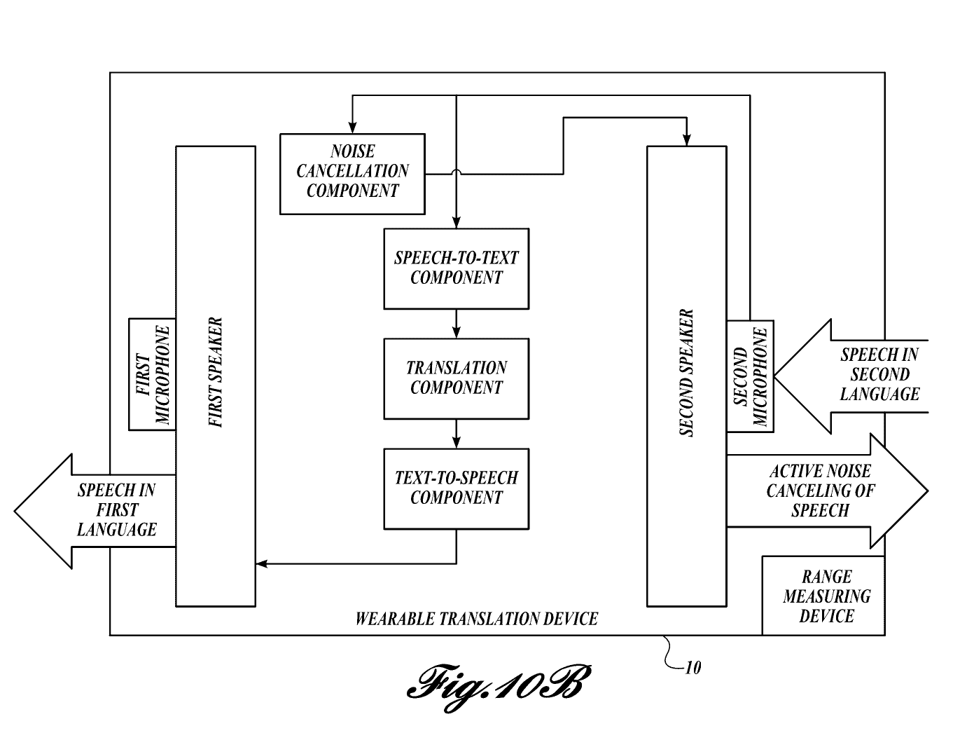

FIGS. 10A and 10B are block diagrams that illustrate exemplary components within the wearable translation device 10 according to various aspects of the present disclosure. As illustrated in FIG. 10A, the wearable translation device 10 includes a first speaker and first microphone oriented toward the user, and a second speaker and a second microphone oriented toward the listener. The first microphone picks up the user's speech in the first language, and provides it to the noise cancellation component and speech-to-text component. Text output in the first language is provided to the translation component, which translates the text to the second language using the dictionaries and other data stored in the computer-readable media such as the removable micro SD cards. The translated text is then provided to the text-to-speech component, which generates a synthetic speech output in the second language based on the translated text. The second speaker is then used to output the synthetic speech output in the second language. The noise cancellation component provides an anti-wave signal based on the user's speech, and outputs the anti-wave signal (or other noise cancellation signal) via the first speaker to reduce the amount of the user's speech that would be heard by the listener. In some embodiments, the noise cancellation signal may be output by the second speaker. Further, in some embodiments, the system may be configured to concurrently operate in reverse when in two-way mode (i.e., the second microphone picks up the listener's speech in the second language, provides it to the speech-to-text component and the noise cancellation component, etc, for eventual output of a synthetic speech output in the first language via the first speaker and a noise cancellation output based on the listener's voice by the second speaker). The range measuring device may be used to measure the distance to the listener and thereby adjust the volume of the second speaker. Also, the second microphone may be used to detect speech in the second language in order to determine which language the second language is. FIG. 10B illustrates the same wearable translation device 10 operating in two-way mode, such that the speech in the second language is now translated to speech in the first language. In some embodiments, the interactions illustrated in FIG. 10B may be happening concurrently with the interactions illustrated in FIG. 10A.

While illustrative embodiments have been illustrated and described, it will be appreciated that various changes can be made therein without departing from the spirit and scope of the invention.

The embodiments of the invention in which an exclusive property or privilege is claimed are defined as follows:

1. A handheld translation device, comprising:
a housing having a first side and a second side, wherein the housing is configured to be held with the first side facing a speaker and the second side facing a listener;
a first loudspeaker positioned within the housing and facing the first side of the housing;
a second loudspeaker positioned within the housing and facing the second side of the housing;
a first microphone facing the first side of the housing for detecting speech input from the speaker;
a second microphone facing the second side of the housing for detecting speech input from the listener;
a computer-readable medium having at least one translation database stored thereon, the at least one translation database providing data to enable translation between a first language and a second language;
a translation engine configured to:
receive speech input from the speaker via the first microphone;
translate the speech input from the first language to the second language using the at least one translation database to create translated speech input;
synthesize translated speech output based on the translated speech input; and
transmit the translated speech output using the second loudspeaker; and
a voice cancelling engine configured to:
generate a voice canceling signal based on the speech input; and
transmit the voice canceling signal via the first loudspeaker or the second loudspeaker.

2. The device of claim 1, wherein the first loudspeaker and the second loudspeaker are each sized to substantially fill the first side of the housing and the second side of the housing, respectively.

3. The device of claim 1, further comprising a rangefinder, and wherein the translation engine is further configured to adjust a volume of the second loudspeaker based on a range to the listener determined using the rangefinder.

4. The device of claim 1, wherein translating the speech input from the first language to the second language includes:
converting the speech input in the first language to text in the first language; and
translating the text in the first language to text in the second language.

5. A translation device configured to:
receive voice input in a first language;
translate the voice input to a second language;
output translated voice output in the second language; and
output a noise cancelling signal based on the voice input.
